(19) United States
(12) Patent Application Publication
(10) Pub. No.: US 2018/0073253 A1
(43) Pub. Date: Mar. 15, 2018

(54) FLOOR TILE WITH VIBRATION AND SHOCK CONTROL

(71) Applicant: REGUPOL AMERICA LLC, Lebanon, PA (US)

(72) Inventor: Dirk HAINBACH, Lancaster, PA (US)

(21) Appl. No.: 15/491,338

(22) Filed: Apr. 19, 2017

Related U.S. Application Data
(63) Continuation-in-part of application No. 15/265,146, filed on Sep. 14, 2016, now abandoned.

(51) Int. Cl. E04F 15/22; B32B 7/02; E04B 5/02; E04B 1/86; E04B 1/82; E04B 1/98; E04F 15/10; E04F 15/02

(52) U.S. Cl. CPC E04F 15/225; B32B 7/02; E04B 5/02; E04B 1/86; E04B 1/8209; B32B 2419/04; E04F 15/107; E04F 15/02177; B32B 2307/56; B32B 2307/102; E04B 1/98

(57) ABSTRACT

A floor panel with shock and vibration control and method of manufacture. The floor panel includes a top layer, a bottom layer, an intermediate layer and a preformed sound dampening layer. The intermediate layer is positioned between the first layer and the second layer. The intermediate layer provides a low natural frequency in response to a dynamic impact and transforms energy into heat in response to a high energy impact. The intermediate layer has a density which is less than a density of the bottom layer. The preformed sound dampening layer extends from the bottom layer in a direction away from the top layer. The sound dampening layer has a density which is less than the density of the bottom layer. The intermediate layer and the sound dampening layer reduce the amount of energy transferred from the floor panel to a structure on which the floor panel is positioned.

### CROSS-REFERENCE TO RELATED APPLICATIONS

This application is a Continuation-in-Part of U.S. patent application Ser. No. 15/265,146 filed on Sep. 14, 2016, and claims priority to that application, which is herein incorporated by reference in its entirety.

### FIELD OF THE INVENTION

This invention relates generally to a floor tile for shock and vibration control and a method of manufacture. In particular, the invention is directed to an acoustic floor tile which controls noise and vibration while providing a dynamic stiffness to provide a stable platform.

### BACKGROUND OF THE INVENTION

Health and fitness clubs have become part of the modern life as well as the modern architecture. From hotels and apartment complexes, to commercial mixed-use buildings, to corporate offices, to multi-purpose sports facilities—many of these have dedicated rooms and areas for fitness, cardio and weightlifting. However, running on treadmills, rhythmic stepping, dropping weights accidentally or slamming weights intentionally on the floor results in low-frequency vibration and structure-borne sound, which may transmit into the building structure and generate unwanted noise and vibration in noise-sensitive rooms and areas in the building complex.

The floor surfaces in such facilities are subject to a considerable amount of hard use. Therefore, in order to increase the durability of the floor surface and tiles, the floor surface and tiles are typically hard and non-cushioned. These surfaces or tiles provide little or no vibration and/or shock control, resulting in the low-frequency vibration and structure-borne sound being transmitted through the structure. The transmission of sound through the structure has a detrimental effect on the location of the facilities and the level and quality of the activities being performed in the facilities.

Therefore, it would be beneficial to provide a flooring or flooring tile which could be used in health and fitness clubs, sports facilities, restaurants, factories and playgrounds which controls noise and vibration. It would also be beneficial to provide the flooring or flooring tile with dimensional stability and dynamic stiffness to provide a stable platform.

### SUMMARY OF THE INVENTION

An object is to provide a floor, floor panel or floor tile which has shock and vibration control which can be used in health and fitness clubs, sports facilities, restaurants, factories, playgrounds and other similar locations.

An object is to provide a floor, floor panel or floor tile provides a low natural frequency in response to dynamic impacts, caused by rhythmic stepping, running, treadmills and other equipment.

An object is to provide a floor, floor panel or floor tile which transforms energy into heat for high energy shocks caused by dropped weights and other sports equipment.

An object is to provide a floor, floor panel or floor tile which transforms an amount of energy into heat (dampening) resulting from a weight dropping on the floor, floor panel or floor tile, and reflects another amount of energy back into a re-bounce, thereby reducing the energy that is transmitted into the building structure, which may result in vibration, structure-borne sound and noise.

An object is to provide a preformed sound dampening layer in which the thickness and density is be uniform and controlled.

An object is to provide a preformed sound dampening layer with superior sound dampening properties at the lowest part of the floor tile, allowing the sound dampening properties of the tile to be enhanced.

An object is to provide sound dampening properties easily tunable depending upon the properties desired. Different preformed rings may be used, providing great flexibility in the manufacture of the tile.

An object is to relieve or reduce the need for compacted air to be present in projections of the bottom layer, making the tile more rigid and less likely to be damaged under the impact of a load.

An object is to provide a floor tile which reduces the time it takes to remove the tile from the mold.

An embodiment is directed to a floor panel with shock and vibration control. The floor panel includes a top layer, a bottom layer, an intermediate layer and a preformed sound dampening layer. The top layer is made from material having a first density. The bottom layer is made from material having a second density, the second density being less than the first density. The intermediate layer is positioned between the first layer and the second layer. The intermediate layer is made of material which provides a low natural frequency in response to a dynamic impact and transforms energy into heat in response to a high energy impact. The preformed sound dampening layer extends from the bottom layer in a direction away from the top layer. The sound dampening layer has a third density which is less than the second density of the bottom layer. The intermediate layer and the sound dampening layer reduce the amount of energy transferred from the floor panel to a structure on which the floor panel is positioned.

An embodiment is directed to a protective floor tile. The floor panel includes a top layer, a bottom layer, an intermediate layer and a preformed sound dampening layer. The intermediate layer is positioned between the first layer and the second layer. The intermediate layer is made of material which provides a low natural frequency in response to a dynamic impact and transforms energy into heat in response to a high energy impact. The intermediate layer has a density which is less than a density of the bottom layer. The preformed sound dampening layer extends from the bottom layer in a direction away from the top layer. The sound dampening layer has a density which is less than the density of the bottom layer. The intermediate layer and the sound dampening layer reduce the amount of energy transferred from the floor panel to a structure on which the floor panel is positioned.

An embodiment is directed to a method of making a floor tile with shock and vibration control. The method includes: positioning a preformed sound dampening layer in a mold; pouring a backing mixture into the mold; positioning a preformed top layer in the mold; applying pressure to the sound dampening layer, the backing mixture and the preformed top layer to form the floor tile; and extracting the floor panel from the mold. The use of the preformed sound dampening layer reduces the demolding time required to remove the floor tile from the mold.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a first illustrative embodiment of a flooring tile according to the present invention with a portion cut away to better shown the layers.

FIG. 2 is a cross-section view of flooring tile of FIG. 1, taken along line 2-2 of FIG. 1.

FIG. 3 is a perspective view of a second illustrative embodiment of a flooring tile according to the present invention with a portion cut away to better show the layers.

FIG. 4 is a cross-section view of flooring tile of FIG. 3, taken along line 4-4 of FIG. 3.

FIG. 5 is a bottom perspective view of the flooring tile of FIG. 3.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

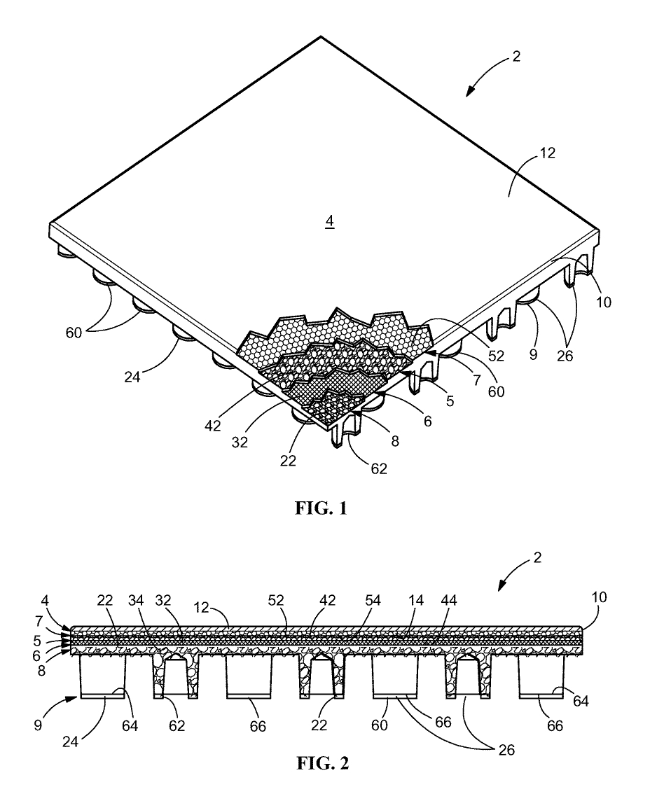

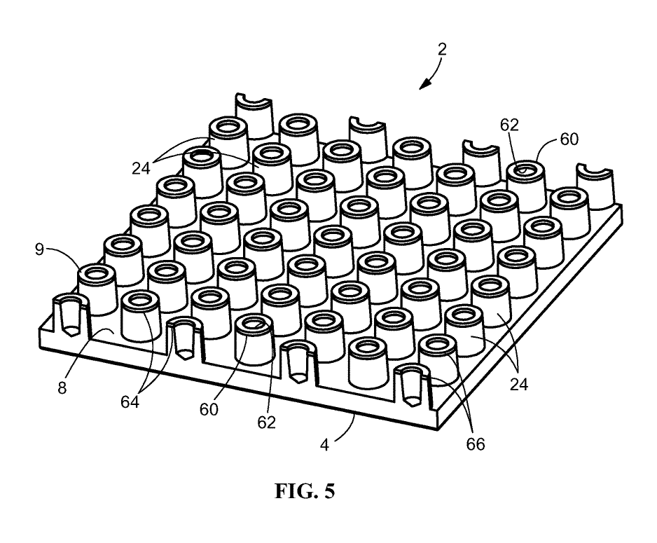

In the embodiments shown in FIGS. 1 through 5, a floor panel or tile 2 has a top layer 4, a bottom layer 8, a first intermediate layer 5, a second intermediate layer or fiber mesh layer 6, a third intermediate layer or mat layer 7 and a sound dampening layer 9. The first intermediate layer 5, the second intermediate layer or fiber mesh layer 6 and the third intermediate layer or mat layer 7 are provided between the top layer 4 and the bottom layer 8. The relative positioning of the first intermediate layer 5, the second intermediate layer or fiber mesh layer 6 and the third intermediate layer or mat layer 7 may vary in different embodiments. The sound dampening layer 9 extends from the bottom layer 8 in a direction away from the top layer 4. A plurality of panels or tiles 2 are installed adjacent to each other to form a cushioned protective surface.

The top layer 4, as shown in the embodiments has a generally square configuration with edges 10 provided on all four sides of the top layer 4. The top layer 4 has a top surface 12 and a bottom surface 14. While the embodiments shown have a square configuration, the invention is not limited to this shape. The top layer 4 may be rectangular, triangular or other shapes or combinations thereof which allow the cushioned protective surface to be formed. The edges 10 may be angled slightly downward with respect to the plane of the top surface 12 of the top layer 4. When the square tiles 2 are positioned adjacent to each other to form an acoustic cushioned protective surface, the edges 10 will abut against each other, thereby forming channels that allow any moisture and/or liquids introduced to the top surface 12 of the top layer 4 to be quickly drained therefrom. This allows the majority of the top surface 12 to stay dry and provide the non-skid characteristics desired even in environments in which the tiles will be exposed to moisture or spills, such as health clubs, etc. The top layer 4 is made from any material having the density and/or porosity properties that provides the desired durability and water-resistant characteristics, such as EPDM rubber, SBR rubber, other rubbers or any combination thereof. As an example, the top layer 4 may be made from 100 percent SBR or 100 percent EPDM or any combination thereof. The density of the top layer 4 generally ranges from 950 g/L to 1475 g/L. The choice of the material used and the thickness ti of the top layer 4 depends upon the durability, resiliency and water-resistant characteristics desired. The top layer 4 may be premanufactured sheet material which has excellent color quality.

In the embodiments shown, the top layer 4 is a pre-molded EPDM laminate plaque with a thickness of between approximately 2 mm to 4 mm. This combination provides the water-resistant, resiliency and durability characteristics to allow the top layer 4 to be used in fitness or health clubs and the like.

The bottom layer 8 has a generally square shape similar to that of the top layer 4 with a top surface 22 and a bottom surface 24. Similar to the top layer 4, the configuration of the bottom layer 8 is not limited to this shape. The bottom layer 8 may be rectangular, triangular or other shapes or combinations thereof which allow the cushioned protective surface to be formed. However, the configuration of the bottom layer 8 is generally consistent with the configuration of the top layer 4. The bottom layer 8 is generally configured to provide cushioning or impact absorption for the tile 2. To facilitate or enhance the cushioning, legs or projections 26 extend from the bottom surface 24 in a direction away from the top surface 22. The dimensions of the legs or projections 26, the number of legs or projections 26 and the positioning of the legs or projections 26 can be varied to provide the desired amount of cushioning. The legs or projections 26 may be hollow or solid as needed to provide the desired amount of cushioning. The bottom layer 8 is made from any material having the density and/or resilient properties that provide the desired cushioning or impact absorption characteristics, such as EPDM rubber, SBR rubber, other rubbers or any combination thereof. In general, the density of the resilient bottom layer 8 will be less than the density of the durable, water resistant top layer 4. The bottom layer is bonded together by a bonding material to maintain the respective pieces of rubber in position. The bonding material can be any suitable cured prepolymer or adhesive which maintains its properties in all environments in which the tiles 2 will be used, including an isocyanate and polyol mixture. The bonding material is generally between 6 to 14 percent by weight of the bottom layer. The thickness of the bottom layer 8 is dependent upon the material chosen and the cushioning or impact absorption characteristics desired.

In the embodiments shown, the bottom layer 8 is made of SBR rubber material made with shredded and cleaned tire rubber content which is bonded together using a polymer material, such as a polyurethane. In one such embodiment elongated SBR string of 6 to 20 mesh and granules of between 1 to 3 mm are used, however the invention is not so limited. While the density of the bottom layer 8 can vary greatly, for the embodiment shown, the density of the SBR material is approximately 800 gram/liter. As the bottom layer 8 is meant to provide cushioning and absorb impact, the density of the bottom layer 8 is generally less than the density of the top layer 4. Consequently, more air space is provided between the fibers of the bottom layer 8 and therefore, the cushioning or resiliency of the bottom layer 8 is enhanced. In addition, as the thickness of the bottom layer 8 is increased, the cushioning properties of the bottom layer 8 may also be increased. The cushioning may also be effected by the size and shape of the particles or fibers of the rubber or other material chosen. Other known variations to the shape of the bottom layer 8 may be made to increase or decrease the resiliency of the tiles 2. More resilient or cushioned applications are more appropriate in a fitness or health clubs.

The sound dampening layer 9 has multiple individual preformed rings 60 which are positioned at free ends of the legs or projections 26 of the bottom layer 8. In the embodiment shown, each ring 60 has a circular configuration with a circular opening 62 positioned in the center of the ring 60. However, the configuration of the sound dampening layer 9 is not limited to this shape. The rings 60 may be a solid disk, square, rectangular, triangular or other shapes or combinations thereof which cooperate with the legs or projections 26. The rings 60 may have the same shape as the legs or projections 26 or may have different shapes. The sound dampening layer 9 is generally configured to provide cushioning or impact absorption for the tile 2. To facilitate or enhance the cushioning, the rings 60 extend from the legs or projections 26 of the bottom layer 8 in a direction away from the top layer 4. The dimensions of the rings 60, the number of rings 60 and the positioning of the rings 60 can be varied to provide the desired amount of cushioning. The shape of the rings 60 may be configured as needed to provide the desired amount of cushioning; for example, the rings 60 may be hollow or solid. The rings 60 of the sound dampening layer 9 are made from any material having the density and/or resilient properties that provide the desired cushioning or impact absorption characteristics, such as EPDM rubber, SBR rubber, other rubbers or any combination thereof. In general, the density of the resilient sound dampening layer 9 will be less than the density of the durable, water resistant top layer 4.

The rings 60 of the sound dampening layer 9 are produced by producing a cylinder of low density rubber. The cylinder is then die cut into rings 60. In the embodiment shown, the rings 60 of the sound dampening layer 9 are made of a premanufactured butyl rubber mat. While the density of the rings 60 can vary greatly, for the embodiment shown, the density of the rubber rings 60 is between approximately 600 gram/liter and 800 gram/liter and the thickness is between 8 mm and 12 mm. In one embodiment, the density of the rubber rings 60 is between approximately 700 gram/liter and the thickness is approximately 10 mm. As the sound dampening layer 9 is meant to provide noise reduction and sound damping, the density and thickness of the sound dampening layer 9 may be varied based on the characteristics desired.

The first intermediate layer 5 is positioned intermediate of the top layer 4 and the bottom layer 8 and has a generally square shape similar to that of the top layer 4 with a top surface 42 and a bottom surface 44. Similar to the top layer 4, the configuration of the first intermediate layer 5 is not limited to this shape. The first intermediate layer 5 may be rectangular, triangular or other shapes or combinations thereof which allow the cushioned protective surface to be formed. However, the configuration of the first intermediate layer 5 is generally consistent with the configuration of the top layer 4. The first intermediate layer 5 is generally configured to provide additional cushioning or impact absorption for the tile 2. The first intermediate layer 5 is made from any material having the density and/or resilient properties that provide the desired cushioning or impact absorption characteristics, such as EPDM rubber, SBR rubber, other rubbers or any combination thereof. In general, the density of the first intermediate layer 5 is consistent with the density of the bottom layer 8 and will be less than the density of the durable, water resistant top layer 4. The first intermediate layer 5 is bonded together by a bonding material to maintain the respective pieces of rubber in position. The bonding material can be any suitable cured prepolymer or adhesive which maintains its properties in all environments in which the tiles 2 will be used, including an isocyanate and polyol mixture. The bonding material is generally between 6 to 14 percent by weight of the bottom layer. The thickness of the first intermediate layer 5 is dependent upon the material chosen and the cushioning or impact absorption characteristics desired.

In the embodiments shown, the first intermediate layer 5 is made of SBR rubber material made with shredded and cleaned tire rubber content which is bonded together using a polymer material, such as a polyurethane. In one such embodiment, elongated SBR string of 6 to 20 mesh and granules of between 1 to 3 mm are used, however the invention is not so limited. While the density of the first intermediate layer 5 can vary greatly, for the embodiment shown, the density of the SBR material is approximately 800 gram/liter. As the first intermediate layer 5 is meant to provide cushioning and absorb impact, the density of the first intermediate layer 5 is generally less than the density of the top layer 4. Consequently, more air space is provided between the fibers of the first intermediate layer 5 and therefore, the cushioning or resiliency of the first intermediate layer 5 is enhanced. In addition, as the thickness to of the first intermediate layer 5 is increased, the cushioning properties of the first intermediate layer 5 may also be increased. The cushioning may also be effected by the size and shape of the particles or fibers of the rubber or other material chosen. Other known variations to the shape of the first intermediate layer 5 may be made to increase or decrease the resiliency of the tiles 2.

The second intermediate layer or fiber mesh layer 6 is positioned intermediate of the top layer 4 and the bottom layer 8. The fiber mesh layer 6 has a generally square shape, similar to that of the top layer 4 and bottom layer 8, with a top surface 32 and bottom surface 34. Similar to the top layer 4, the configuration of the fiber mesh layer 6 is not limited to this shape. The fiber mesh layer 6 may be rectangular, triangular or other shapes or combinations thereof which allow the cushioned protective surface to be formed. However, the configuration of the fiber mesh layer 6 is generally consistent with the configuration of the top layer 4. The fiber mesh layer 6 is generally configured to provide maximum dimensional stability for the tile 2, as will be more fully described below. The fiber mesh layer 6 is made from any material having the dimensional stability and bonding properties that provide the desired stability and bonding characteristics, such as glass, natural fiber or other types of material or any combination thereof. The thickness of the fiber mesh layer 6 is dependent upon the material chosen and the difference in density between the top layer 4 and the bottom layer 8.

The third intermediate layer or mat layer 7 is positioned intermediate of the top layer 4 and the bottom layer 8. The mat layer 7 has a generally square shape, similar to that of the top layer 4 and bottom layer 8, with a top surface 52 and bottom surface 54. Similar to the top layer 4, the configuration of the mat layer 7 is not limited to this shape. The mat layer 7 may be rectangular, triangular or other shapes or combinations thereof which allow the cushioned protective surface to be formed. However, the configuration of the mat layer 7 is generally consistent with the configuration of the top layer 4. The mat layer 7 is generally configured to provide internal dampening or energy absorption, such as, but not limited to shock and vibration control for the tile 2, as will be more fully described below. The mat layer 7 is made from any material having the energy absorption and bonding properties that provide the desired internal dampening and bonding characteristics, such as butyl rubber. The thickness of the mat layer 7 is dependent upon the material chosen.

The mat layer 7 provides shock and vibration control, which is advantageous in many environments and industries, including, but not limited to, the health and fitness industry. When the mat layer 7 is exposed to dynamic impacts, caused by such activities/equipment as rhythmic stepping, running, treadmills and other equipment, the mat layers facilitate the translation of such dynamic impacts to a low natural frequency which minimizes the vibration transmitted to the building structure, thereby reducing the transmitted noise and vibration associated with such activities.

The mat layer 7 is configured to help reduce the amount of energy resulting from high energy shocks, such as a weight dropping on the floor, from being transmitted into the structure. The mat layer absorbs the impact and transforms a certain amount of energy into heat (damping) and reflects another amount of energy back into a re-bounce. This minimizes the amount of energy which is transmitted into the building structure, thereby minimizing the vibration, structure-borne sound, and noise transmitted through the structure. In various embodiments, the mat layer 7 is configured to provide maximum energy absorption through transformation into heat, thereby minimizing re-bounce and minimizing energy transmission into the building structure.

In the embodiment shown, the mat layer 7 is made of a premanufactured butyl rubber mat. While the density of the mat layer 7 can vary greatly, for the embodiment shown, the density of the butyl rubber mat is between approximately 900 gram/liter and 1200 gram/liter and the thickness is between 3 mm and 16 mm. As the mat layer 7 is meant to absorb impact and provide noise reduction, the density of the mat layer 7 is generally greater than the density of the bottom layer 8. In addition, as the thickness of the mat layer 7 is increased, the impact absorption and noise reduction properties of the first intermediate layer 5 may also be increased. The properties may also be effected by the size and shape of the particles or fibers of the butyl rubber or other material chosen. Other known variations to the shape of the mat layer 7 may be made to increase or decrease the resiliency of the tiles 2.

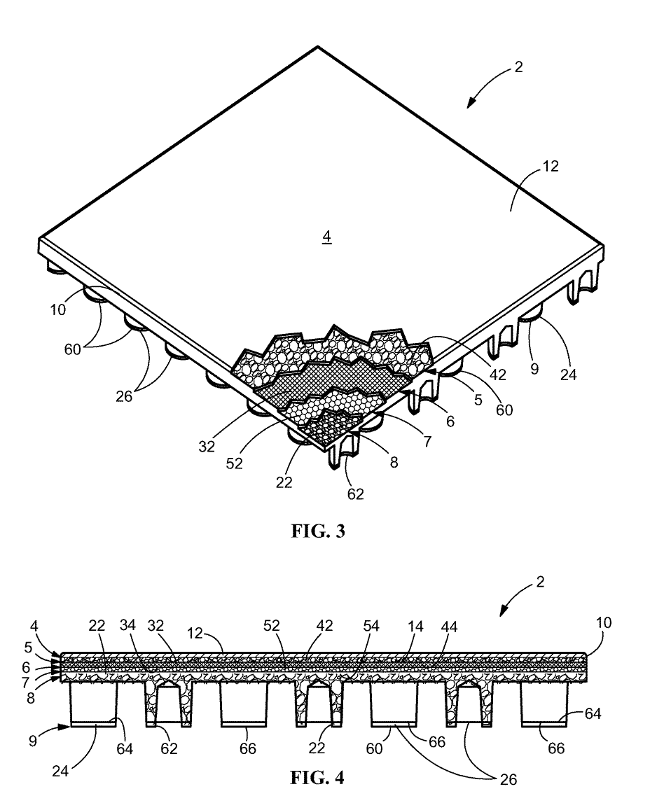

In various embodiments, an adhesive may sprayed or applied to the top surface 52 of the mat layer 7. The adhesive may be a polyurethane or acrylic glue or any other adhesive able to bond the mat layer 7 to the top layer 4 (as shown in FIG. 1) or to bond the mat layer 7 to the fiber mesh layer 6 (as shown in FIG. 3). In various embodiments, the adhesive may also be sprayed or applied to the bottom surface 14 of the top layer 4 (FIG. 1) or to the bottom surface 34 of the fiber mesh layer 6 (FIG. 3). The adhesive used on the top surface may be the same or different than the adhesive used on the bottom surface.

Each tile 2 may be produced using the type of mold and press that is commonly known and used in the industry. For such tiles 2, the rings 60 are positioned in the mold, at the bottom of the forms for the legs or projections 26. With the rings 60 properly positioned, a backing mixture is poured into the mold on the press. The mixture forms the bottom layer 8 and is made of SBR rubber or other rubbers, as previously described, mixed with the type of prepolymer material described. As the mixture is poured into the mold, top surfaces 64 of the rings 60 and the bottom surface 66 of legs or projections 26 of the bottom layer 8 are periodically in engagement along the entire length and width of the rings 60. In this pre-compressed condition, the top surfaces 64 and bottom surfaces 66 of the legs or projections 26 have random air voids provided therebetween.

Referring to the embodiment shown in FIGS. 1 and 2, after the backing mixture is poured into the mold, the backing mixture is leveled. This ensures that the backing mixture will be distributed uniformly in the mold and that the top surface of the backing mixture will be relatively smooth. The amount of backing mixture poured into the mold is accurately controlled to provide the resilient characteristics desired.

The fiber mesh 6 is next positioned in the mold. The fiber mesh 6 is positioned over the backing mixture provided in the mold. As the backing mixture has been leveled, a bottom surface 34 of the fiber mesh 6 is positioned on the top surface of the backing mixture, such that the bottom surface 34 and top surface are periodically in engagement along the entire length and width of the fiber mesh 6. In this position, the bottom surface 34 and top surface of the backing mixture have random air voids provided therebetween. The length and width of the fiber mesh 6 is dimensioned to be approximately equal to the length and width of an inner cavity of the mold.

The first intermediate layer 5 is then poured into the mold and is leveled. This ensures that the first intermediate layer 5 will be distributed uniformly in the mold and that the top surface 42 of the first intermediate layer 5 will be relatively smooth. The amount of first intermediate layer 5 poured into the mold is accurately controlled to provide the resilient characteristics desired.

The mat layer 7 is next positioned in the mold. The mat layer 7 is positioned over the first intermediate layer 5. As the first intermediate layer 5 has been leveled, a bottom surface 54 of the mat layer 7 is positioned on the top surface 42 of the first intermediate layer 5, such that the bottom surface 54 and top surface 42 are periodically in engagement along the entire length and width of the mat layer 7. In this position, the bottom surface 54 and top surface 42 of the first intermediate layer 5 have random air voids provided therebetween. The length and width of the mat layer 7 is dimensioned to be approximately equal to the length and width of an inner cavity of the mold.

The adhesive is applied to the top surface 52 of the mat layer 7. The adhesive may be sprayed, spread or applied in any known manner to the top surface 52.

The pre-formed top layer 4 is next positioned in the mold. The top layer 4 is positioned over and covers the adhesive and the mat layer 7. The bottom surface 14 of the top layer 4 is positioned on a top surface 52 of the mat layer 7, such that the bottom surface 14 of the top layer 4 and top surface 52 of the mat layer 7 are periodically in engagement along the entire length and width of the top layer 4. In this pre-compressed condition, the bottom surface 14 and top surface 52 have random air voids provided therebetween. The length and width of the top layer 4 is dimensioned to be approximately equal but slightly larger than the length and width of the mold. The dimensions of the top layer 4 do not prevent the top layer 4 from lying flat on the top surface of the mat layer 7, even around the edges where the top layer 4 contacts the walls of the cavity.

Referring to the embodiment shown in FIGS. 3 and 4, the rings 60 are positioned in the mold, at the bottom of the forms for the legs or projections 26. With the rings 60 properly positioned, a backing mixture is poured into the mold on the press. After the backing mixture is poured into the mold, the backing mixture is leveled. This ensures that the backing mixture will be distributed uniformly in the mold and that the top surface of the backing mixture will be relatively smooth. The amount of backing mixture poured into the mold is accurately controlled to provide the resilient characteristics desired.

The mat layer 7 is next positioned in the mold. The mat layer 7 is positioned over the backing mixture. As the backing mixture has been leveled, a bottom surface 54 of the mat layer 7 is positioned on the top surface of the backing mixture 5, such that the bottom surface 54 and top surface of the backing mixture are periodically in engagement along the entire length and width of the mat layer 7. In this position, the bottom surface 54 and top surface of the backing mixture have random air voids provided therebetween. The length and width of the mat layer 7 is dimensioned to be approximately equal to the length and width of an inner cavity of the mold.

The adhesive is applied to the top surface 52 of the mat layer 7. The adhesive may be sprayed, spread or applied in any known manner to the top surface 52.

The fiber mesh 6 is next positioned in the mold. The fiber mesh 6 is positioned over and covers the adhesive and the mat layer 7. The bottom surface 34 of the fiber mesh 6 is positioned on a top surface 52 of the mat layer 7, such that the bottom surface 34 of the fiber mesh 6 and top surface 52 of the mat layer 7 are periodically in engagement along the entire length and width of the top layer 4. In this pre-compressed condition, the bottom surface 34 and top surface 52 have random air voids provided therebetween. The length and width of the fiber mesh 6 is dimensioned to be approximately equal to the length and width of the inner cavity of the mold.

The first intermediate layer 5 is then poured into the mold and is leveled. This ensures that the first intermediate layer 5 will be distributed uniformly in the mold and that the top surface 42 of the first intermediate layer 5 will be relatively smooth. The amount of first intermediate layer 5 poured into the mold is accurately controlled to provide the resilient characteristics desired.

The pre-formed top layer 4 is next positioned in the mold. The pre-formed top layer 4 is positioned over the first intermediate layer 5. As the first intermediate layer 5 has been leveled, a bottom surface 14 of the pre-formed top layer 4 is positioned on the top surface 42 of the first intermediate layer 5, such that the bottom surface 14 and top surface 42 are periodically in engagement along the entire length and width of the mat layer 7. In this position, the bottom surface 14 and top surface 42 of the first intermediate layer 5 have random air voids provided therebetween. The length and width of the top layer 4 is dimensioned to be approximately equal but slightly larger than the length and width of the mold. The dimensions of the top layer 4 do not prevent the top layer 4 from lying flat on the top surface of the mat layer 7, even around the edges where the top layer 4 contacts the walls of the cavity.

In both embodiments, with the sound dampening layer 9, the bottom layer 8, the mat layer 7, the fiber mesh layer 6, the first intermediate layer 5 and the top layer 4 properly positioned in the mold, a ram or head of the press engages the top layer 4 and exerts a significant pressure thereon, causing the sound dampening layer 9, the bottom layer 8, the mat layer 7, the fiber mesh layer 6, the first intermediate layer 5 and the top layer 4 to compress, thereby eliminating any unwanted pockets of air between the layers.

As the pressure is applied, the mold is maintained at an elevated temperature. The combination of the pressure and heat causes any adhesive and/or prepolymer to cure or solidify. The curing of the adhesive and/or prepolymer ensures that the layers will be bonded together. A more detailed description is provide in U.S. Pat. No. 8,192,823 which is hereby incorporated by reference in its entirety.

At the appropriate time, the ram or head of the press is retracted from the mold. With the head removed, the molded tile 2 is removed. This process is repeated for each tile. In the alternative, each press may cooperate with more than one mold at a time, thereby allowing numerous tiles to be made simultaneously.

The utilization of the prefabricated rings or sound dampening layer allows the thickness of the sound dampening layer to be uniform and controlled. As the prefabricated sound dampening layer is cut from pre-molded material, the thickness of the rings can be controlled and accurately duplicated.

The utilization of the prefabricated rings or sound dampening layer also positions superior sound dampening properties at the lowest part of the molded tile 2, allowing the sound dampening properties of the tile to be enhanced. The sound dampening properties are easily tunable depending upon the properties desired. Different preformed cylinders made of different material and density may be cut and used to manufacture the rings, thereby providing great flexibility in the manufacture of the tile. Additionally, the thickness of the rings may be altered to add additional flexibility in the manufacture of the tile.

In addition, the use of the rings relieve or reduce the need for compacted air to be present in the legs or projections 26 of the bottom layer 8. Consequently, as the legs or projections 26 can be made more rigid, the legs or projections 26 are less likely to be damaged, fail or blow out when deformed under the impact of a load.

The use of the preformed rings also significantly reduces the demolding time (i.e. the time it takes to remove the tile from the mold). As the rings are preformed and already cured, the demolding of the tile from the mold can be reduced, for example by 4 minutes or more per tile. Additionally, as the tile is more easily removed from the mold and as the preforming of the rings is more easily controlled (due in part to the shape of the molds), the waste associated with the making of the tile is reduced, for example, by 15%.

The utilization of a prefabricated top layer allows the thickness of the top layer to be more uniform and controlled. As the prefabricated top layer is cut from pre-molded material, the thickness can be controlled. In the prior art, the top layer may have areas in which the thickness of the material was “thin” due to the vagaries of pouring. This could lead to uneven wear of the tiles. Other advantages of a preformed top layer are known, including, but not limited to, the ability to enhance the aesthetics.

The durability of the tiles of the present invention is also enhanced. As the density of the prefabricated top layer is greater than previously obtainable, the top layer will be less porous. As less liquid will be able to penetrate the tile, the durability of the tile over time will be enhanced. This also allows the tile to be used in environments not previously considered acceptable (i.e. restaurants).

As the density of the top layer 4 increases, the difference in density between the top layer 4 and the bottom layer 8 can cause dimensional instability of the tile 2. However, the use of the fiber mesh layer 6 reduces the dimensional instability of the tile 2 due to the density difference between the top layer 4 and the bottom layer 8.

In order to minimize the internal stresses of the tile 2, the fiber mesh layer 6 may have a dimensional coefficient which is between the dimensional coefficient of the top layer and the dimensional coefficient of the bottom layer. This allows the dimensional changes of the layers to occur in a manner that does not result in the failure of any of the layers or the bonds therebetween.

Dimensional stability is the degree to which a material maintains its original dimensions when subjected to changes in temperature and humidity. Dimensional instability can be caused by the linear expansion/contraction and thickness swelling/shrinkage of the various layers of the tiles 2 when exposed to changing temperatures and humidity conditions.

In prior art panels, in which the top layer is adhered or bonded to the bottom layer, the interface between the top layer and the bottom layer is subject to significant stresses as the top layer and bottom layer expand and contract at different rates when exposed to changes in temperature and humidity conditions. These high internal stresses can cause the tiles to buckle, curl, gap or have the top layer physically separate from the bottom layer. Gapping may result in debris filling the gaps between the stressed tiles which causes maintenance and health issues. Lifting edges and separation of the top layer from the bottom layer can cause tripping and other safety concerns. However, as the top layer and bottom layer must be made from different compositions having different densities in order to obtain the characteristics desired, the large internal stresses are inherent in the prior art tiles.

In the panels of the present invention, the fiber mesh layer 6 acts as a buffer the various layers. As the fiber mesh layer 6 is included as a buffer between the various layers, the fiber mesh layer 6 can be made of material to optimize the dimensional stability in both the linear and thickness direction. In addition, the composition of the fiber mat layer 6 is interwoven to allow the relative movement of the fibers with respect to each other. This allows the top surface 32 of the fiber mesh layer 6 to move relative to the bottom surface 34.

As the tile 2 is subject to temperature and moisture variations, the respective layers expand and contract at different rates. However, the fiber mesh layer 6 remains relatively stable when exposed to changes in temperature and humidity conditions. Consequently, as the respective layers change dimensionally, whether by expansion, contraction, swelling, shrinkage or other, the fiber mesh layer 6 can move to accommodate the changes dimensionally of the respective layers, thereby maintaining the integrity there between.

The floor panel or tile 2 allows the dimensional changes of the respective layers to be isolated and substantially independent from the dimensional changes of the other layers, allowing the high internal stresses present in the prior art tiles are essentially eliminated, thereby preventing the tiles from buckling, curling, gaping or having the top layer physically separate from the bottom layer. Consequently, maintenance, health and safety concerns are reduced.

The floor panel or tile 2 reduces the transmission of energy into the building structure, which results in vibration and noise control. In addition, the floor panel or tile 2 minimizes the amount of re-bounce, decreases the risk of potential injuries to the athlete and other people nearby, and decreases the risk of damage to equipment or the building structure.

While the invention has been described with reference to a preferred embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials and components, without departing from the spirit or essential characteristics thereof. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A floor panel with shock and vibration control, the floor panel comprising:
a top layer made from material having a first density;
a bottom layer made from material having a second density, the second density being less than the first density;
an intermediate layer positioned between the first layer and the second layer, the intermediate layer made of material which provides a low natural frequency in response to a dynamic impact and transforms energy into heat in response to a high energy impact;
a preformed sound dampening layer extending from the bottom layer in a direction away from the top layer, the sound dampening layer having a third density which is less than the second density of the bottom layer;
wherein the intermediate layer and the sound dampening layer reduce the amount of energy transferred from the floor panel to a structure on which the floor panel is positioned.

2. The floor panel as recited in claim 1, wherein the bottom layer includes a plurality of projections which extend from the bottom layer in a direction away from the top layer.

3. The floor panel as recited in claim 2, wherein the preformed sound dampening layer includes multiple preformed rings which are positioned at free ends of the legs.

4. The floor panel as recited in claim 1, wherein the sound dampening layer is made from any material having cushioning and impact absorption properties that provide a desired cushioning of the floor panel.

5. The floor panel as recited in claim 4, wherein the sound dampening layer is made from butyl rubber.

6. The floor panel as recited in claim 4, wherein the sound dampening layer has a density of between approximately 600 gram/liter and 800 gram/liter.

7. The floor panel as recited in claim 4, wherein the sound dampening layer has a thickness between 8 mm and 12 mm.

8. The floor panel as recited in claim 4, wherein the intermediate layer is made from any material having energy absorption and bonding properties that provide a desired internal dampening and bonding.

9. The floor panel as recited in claim 8, wherein the intermediate layer is made from butyl rubber.

10. The floor panel as recited in claim 8, wherein the intermediate layer is a preformed mat.

11. The floor panel as recited in claim 8, wherein the intermediate layer has a density which is less than the second density of the bottom layer.

12. The floor panel as recited in claim 8, wherein the intermediate layer has a density of between approximately 900 gram/liter and 1200 gram/liter.

13. The floor panel as recited in claim 8, wherein the intermediate layer has a thickness between 3 mm and 16 mm.

14. A floor panel with shock and vibration control, the floor panel comprising:
a top layer;
a bottom layer;
an intermediate layer positioned between the first layer and the second layer, the intermediate layer made of material which provides a low natural frequency in response to a dynamic impact and transforms energy into heat in response to a high energy impact, the intermediate layer has a density which is less than a density of the bottom layer;
a preformed sound dampening layer extending from the bottom layer in a direction away from the top layer, the sound dampening layer having a density which is less than the density of the bottom layer;
wherein the intermediate layer and the sound dampening layer reduce the amount of energy transferred from the floor panel to a structure on which the floor panel is positioned.

15. The floor panel as recited in claim 14, wherein the density of the sound dampening layer is less than the density of the intermediate layer.

16. The floor panel as recited in claim 14, wherein the bottom layer includes a plurality of projections which extend from the bottom layer in a direction away from the top layer, and the preformed sound dampening layer includes multiple preformed rings which are positioned at free ends of the legs.

17. The floor panel as recited in claim 16, wherein the multiple preformed rings are made from butyl rubber.

18. The floor panel as recited in claim 17, wherein the multiple preformed rings have a density of between approximately 600 gram/liter and 800 gram/liter.

19. The floor panel as recited in claim 18, wherein the multiple preformed rings have a thickness between 8 mm and 12 mm.

20. A method of making a floor tile with shock and vibration control, the method comprising:
positioning a preformed sound dampening layer in a mold;
pouring a backing mixture into the mold;
positioning a preformed top layer in the mold;
applying pressure to the sound dampening layer, the backing mixture and the preformed top layer to form the floor tile;
extracting the floor panel from the mold;
wherein the preformed sound dampening layer reduces the demolding time required to remove the floor tile from the mold.
